(19) United States
(12) Patent Application Publication
(10) Pub. No.: US 2023/0255215 A1
(43) Pub. Date: Aug. 17, 2023

(54) COOKIE CUTTER APPARATUS AND SYSTEM

(71) Applicants: Jason Miconi, Higganum, CT (US); Jason A. Finkle, Clinton, CT (US)

(72) Inventors: Jason Miconi, Higganum, CT (US); Jason A. Finkle, Clinton, CT (US)

(21) Appl. No.: 17/671,769

(22) Filed: Feb. 15, 2022

(51) Int. Cl. A21C 11/10

(52) U.S. Cl. CPC A21C 11/106

(57) ABSTRACT

A cookie cutter apparatus comprising: a horizontal handle, the horizontal handle having a first end, and a second end on an opposite end of the horizontal handle from the first end; a first side member attached to one end of the horizontal handle; a second side member attached to a second end of the horizontal handle; a first slide plate configured to removeably attach to the first side member and second side member, the slide plate having a first cookie cutter pattern. A cookie cutter system comprising: a horizontal handle, the horizontal handle having a first end, and a second end on the opposite end of the horizontal handle from the first end; a first side member attached to one end of the horizontal handle; a second side member attached to a second end of the horizontal handle; a lid configured to removeably attach to the first side member and the second side member; a main body, configured to removeably attach to the lid; a first slide plate configured to removeably attach to the first side member and second side member, the slide plate having a first cookie cutter pattern; a second slide plate configured to removeably attach to the first side member and second side member, the second slide plate having a second cookie cutter pattern; a third slide plate configured to removeably attach to the first side member and second side member, the third slide plate having a third cookie cutter pattern; and where the main body is configured to hold a plurality of slide plates.

### TECHNICAL FIELD

The present invention relates generally to cookie cutter apparatuses and systems, and more particularly, to a cookie cutter apparatus and system with interchangeable slides.

### BACKGROUND

Dough cutters, and more particularly, cookie cutters, are used in many kitchens. Typically, they are comprised of a handle portion having a rigid cutting wall with a sharp cutting edge. Generally, they are an integral structure and are designed to make only one shape of cookie. Thus, a cookie maker had to have a wide assortment of cookie cutters in order to make various shapes of cookies or cookies with various designs therein. Not only does this require the purchase of a large number of cutters in order to make an assortment of cookies, but it also requires more than necessary storage space which is usually a premium item in most kitchens.

Thus, there is a need for a cookie cutter apparatus and system that overcomes the above listed and other disadvantages.

### SUMMARY OF THE INVENTION

The invention relates to a cookie cutter apparatus comprising: a horizontal handle, the horizontal handle having a first end, and a second end on an opposite end of the horizontal handle from the first end; a first side member attached to one end of the horizontal handle; a second side member attached to a second end of the horizontal handle; a first slide plate configured to removeably attach to the first side member and second side member, the slide plate having a first cookie cutter pattern.

The invention also relates to a cookie cutter system comprising: a horizontal handle, the horizontal handle having a first end, and a second end on the opposite end of the horizontal handle from the first end; a first side member attached to one end of the horizontal handle; a second side member attached to a second end of the horizontal handle; a lid configured to removeably attach to the first side member and the second side member; a main body, configured to removeably attach to the lid; a first slide plate configured to removeably attach to the first side member and second side member, the slide plate having a first cookie cutter pattern; a second slide plate configured to removeably attach to the first side member and second side member, the second slide plate having a second cookie cutter pattern; a third slide plate configured to removeably attach to the first side member and second side member, the third slide plate having a third cookie cutter pattern; and where the main body is configured to hold a plurality of slide plates.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 shows a perspective view of the disclosed cookie cutter apparatus;

FIG. 2 shows a slide plate slid out from the first and second side members;

FIG. 3 shows a perspective assembly view of the cookie cutter apparatus;

FIG. 4 shows a front view of the handle and the two side members;

FIG. 5 is a bottom view of the handle and the two side members;

FIG. 6 is a top view of the handle and the two side members;

FIG. 7 is a front view of the second side member;

FIG. 8 is a first side view of the second side member;

FIG. 9 is a second side view of the second side member;

FIG. 10 is a top view of one embodiment of the handle;

FIG. 11 is a perspective view of one embodiment of the handle;

FIG. 12 is a bottom view of one slide plate;

FIG. 13 is a bottom view of another slide plate;

FIG. 14 is a rear view of the slide plate from FIG. 12;

FIG. 15 is a top view of the slide plate from FIG. 12;

FIG. 16 shows a perspective view of a storage container;

FIG. 17 shows a side view of the storage container;

FIG. 18 is a perspective assembly view of the storage container;

FIG. 19 is a perspective view of a lateral support member;

FIG. 20 is a side view of the lateral support member; and

FIG. 21 is a front view of the lateral support member.

### DETAILED DESCRIPTION OF THE INVENTION

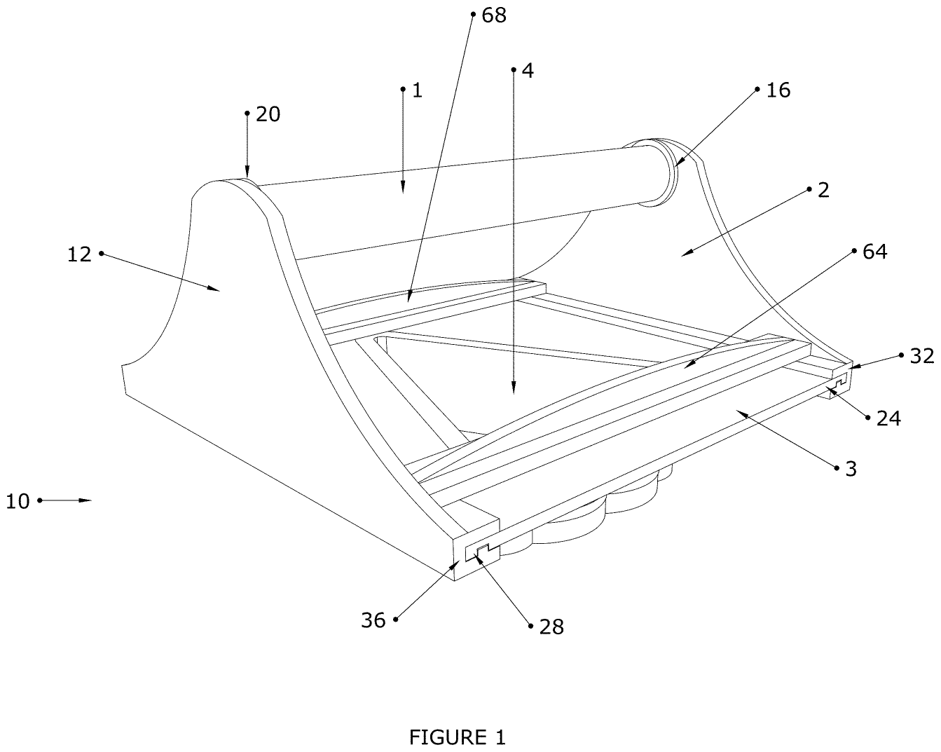

FIG. 1 shows a perspective view of the disclosed cookie cutter apparatus 10. The apparatus 10 comprises a handle 1. The handle 1 may be a round dowel, or any other suitable shape for a handle. The handle 1 is attached to a first side member 2 and a second side member 12. The handle 1 may be attached to the side members 2, 12 via glue in rings 16, 20, respectively. In other embodiments, the handle 1 may be molded as one piece with the first and second side members 2, 12. In still other embodiments, the handle 1 may be attached to the first and second side member 2, 12 via any suitable attachment or connecting means. A slide plate 3 is shown removably attached to the first and second side members 2, 12. The slide plate 3 may slide into grooves or slots located at the bottom of side members 2, 12. In the shown embodiment, the slide plate 3 has a first slide square groove 24 and a second slide square groove 28. The first side member 2 has a first square groove 32 that is configured to slideably mate with the first slide square groove 24. Similarly, the second side member 12, has a second square groove that is configured to slideably mate with the second slide square groove 28. The slide plate 3 also comprises a cookie cutter pattern 4. In this embodiment, the slide 3 has a cookie cutter pattern 4 that has a shape of a slice of pie. The slide plate 3 may be removably attached to the first side member 2 and second side member 12 through other means, such as magnetic means, interference fit, dove tails, snaps, screw, hinged locking straps, and any other suitable connecting means, that will allow the slide plate 3 to be quickly changed out with another slide plate with respect to the two side members 2, 12. In one embodiment, the first side member 2 is parallel to the second side member 12, and the slide plate 3 is orthogonal to the first side member 2 and the second side member 12, when the slide plate 3 is attached to the first and second side members 2, 12. The distance between the handle 1 and the slide plate 3 when the slide plate is attached to the first side member 2 and second side member 12 is large enough for the fingers of a user to grab onto the handle 1 without the fingers abutting the slide plate 3. In other words, the handle 1 is far enough away from the installed slide plate 3 so a user can comfortably hold the handle and cut dough, without his or her fingers abutting against the slide plate 3. Attached to the top of the first square groove 32 and second square groove 36 may be an optional first lateral support 64. An optional second lateral support 68 may also be attached to the top of the first square groove 32 and second square groove 36.

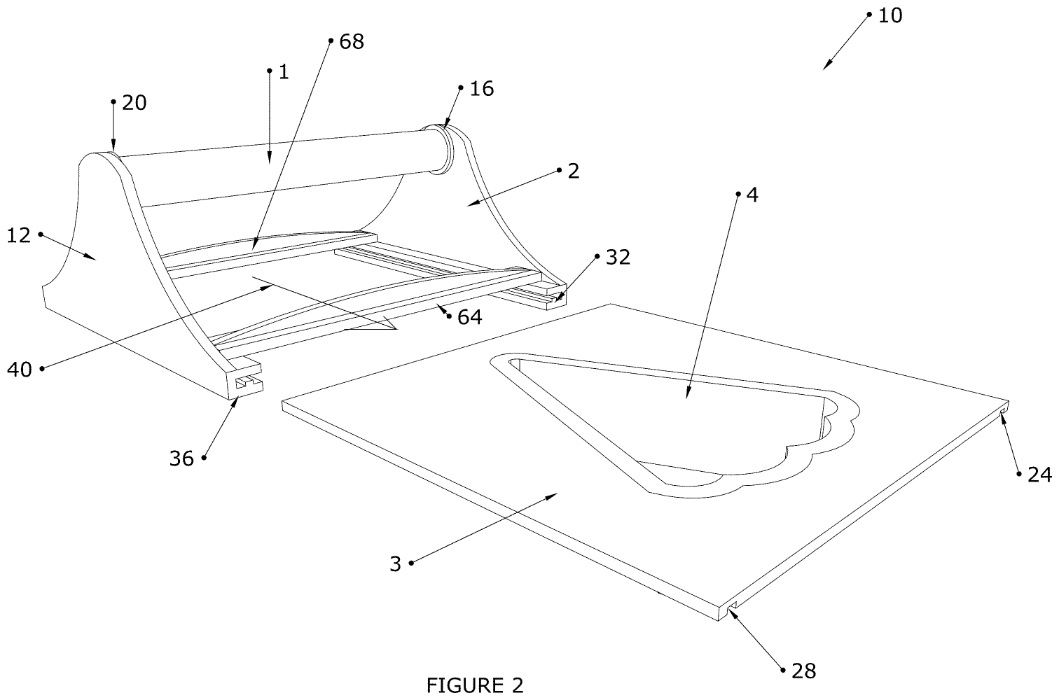

FIG. 2 shows the slide plate 3 slid out from the first and second side member 2, 12. Arrow 40 shows a direction that the slide plate 3 may be slid out from the two side members 2, 12. In other embodiments, the slide plate 3 may be slid out in the direction opposite of arrow 40, in still other embodiments, the slide plate 3 may slid out from the two side members 2, 12 in both the direction of the arrow 40, and in the direction opposite of arrow 40.

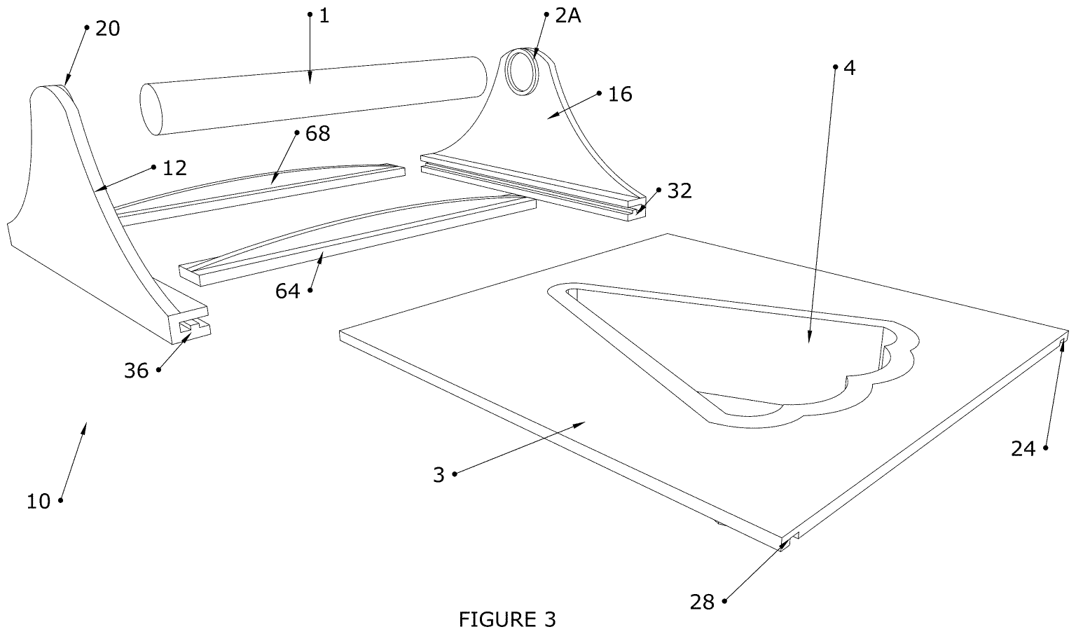

FIG. 3 shows a perspective assembly view of the cookie cutter apparatus 10. In other embodiments, the handle 1 and the two side members 2, 12 may be manufactured as one piece, for instance they may be molded as one piece, or 3D printed as one piece, or otherwise manufactured as one piece. In other embodiments, the handle 1 and the two side members 2, 12, and two lateral support members 64, 68 may be manufactured as one piece, for instance they may be molded as one piece, or 3D printed as one piece, or otherwise manufactured as one piece.

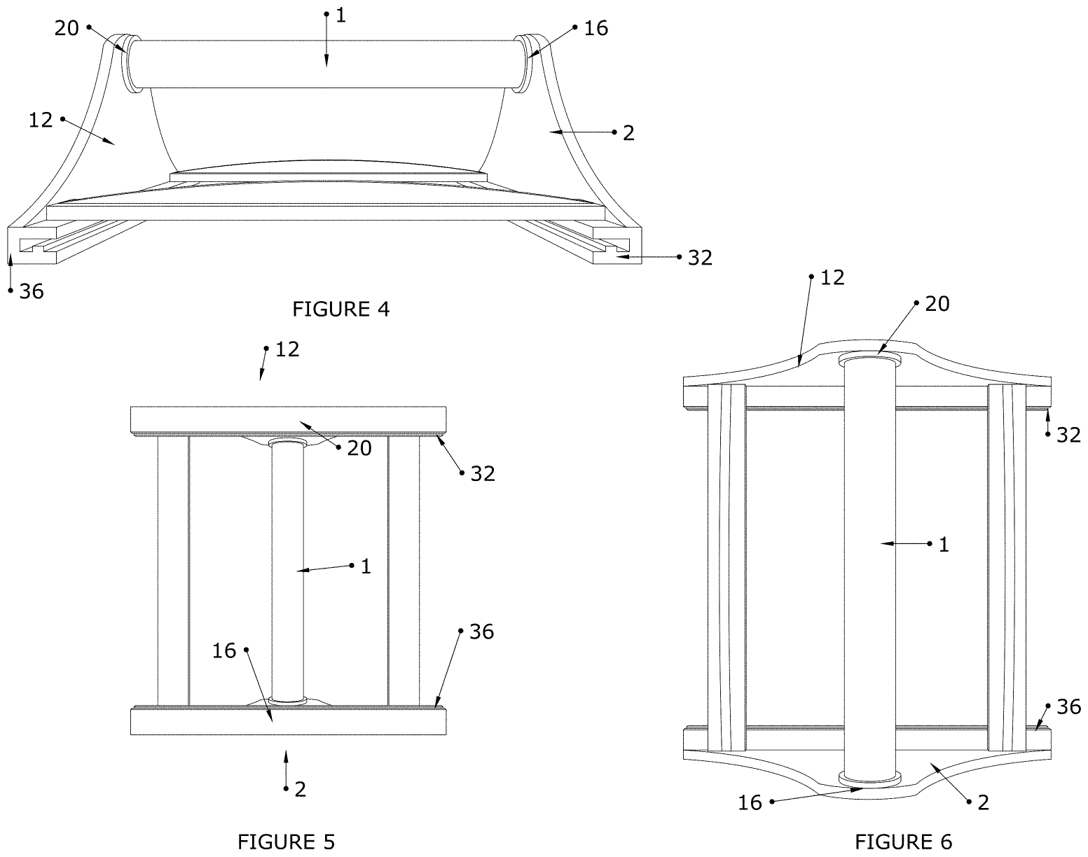

FIG. 4 shows a front view of the handle 1 and the two side members 2, 12. In this view, the slide plate 4 has been removed.

FIG. 5 is a bottom view of the handle 1 and the two side members 2, 12.

FIG. 6 is a top view of the handle and the two side members 2, 12.

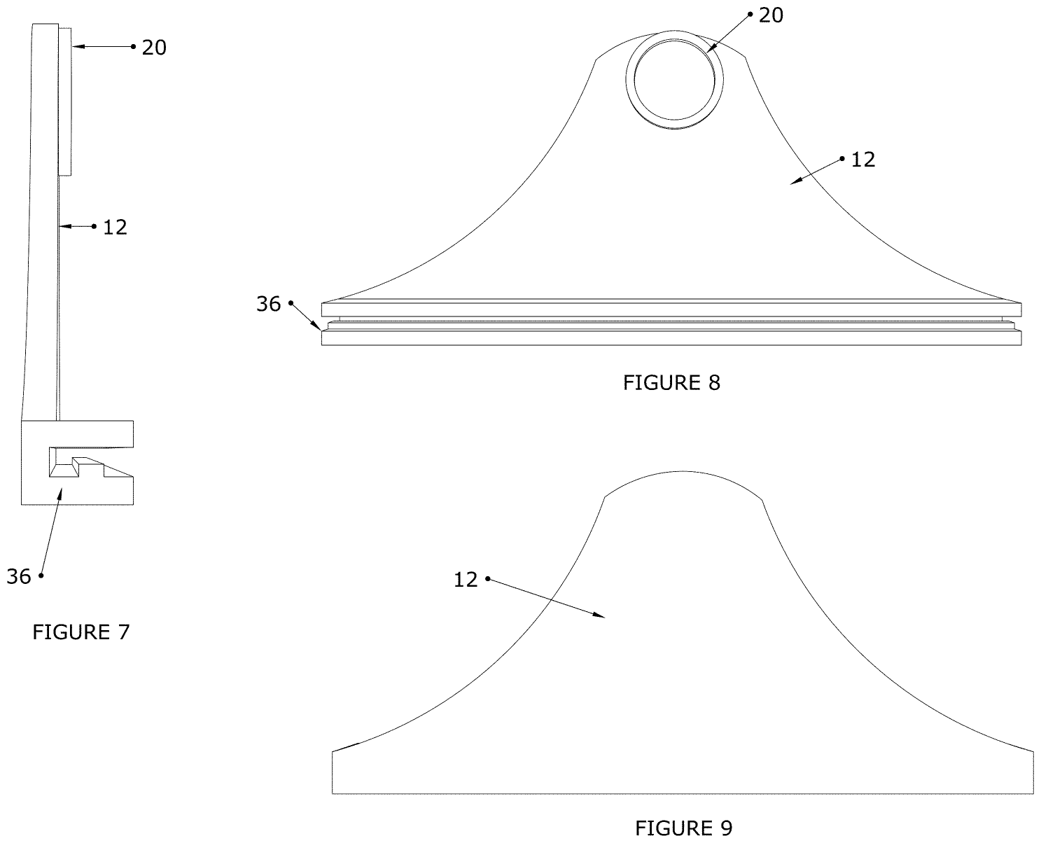

FIG. 7 is a front view of the second side member 12.

FIG. 8 is a first side view of the second side member 12.

FIG. 9 is a second side view of the second side member 12.

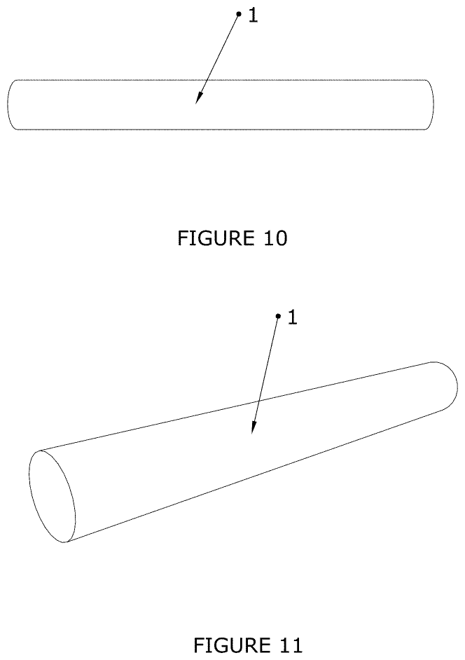

FIG. 10 is a top view of one embodiment of the handle 1.

FIG. 11 is a perspective view of one embodiment of the handle 1.

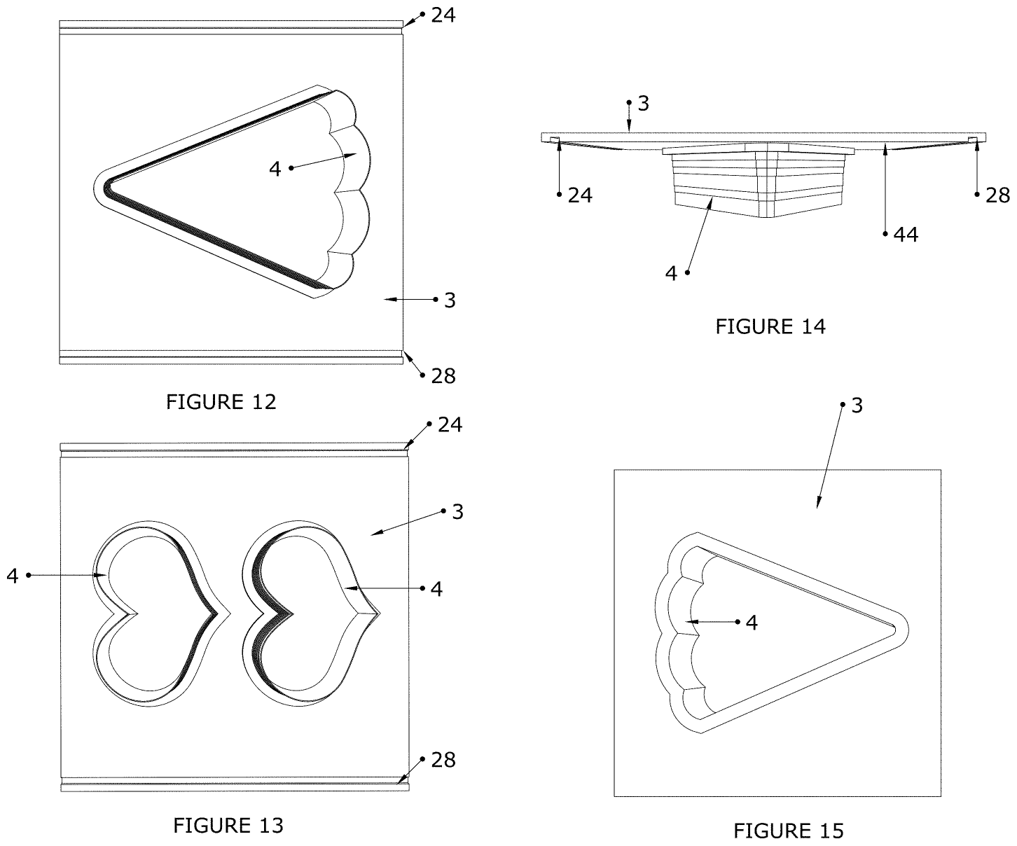

FIG. 12 is a bottom view of one slide plate 3.

FIG. 13 is a bottom view of another slide plate 3, but this slide plate 3 has a cookie cutter pattern 4 of two hearts.

FIG. 14 is a rear view of the slide plate 3 from FIG. 12. In this view, the cookie cutter pattern 4 extends past the bottom surface 44 of the slide plate 3. This facilitates the cutting of cookie dough or any other type of dough, to form the shape of the cookie cutter pattern 4 when the cookie cutter apparatus 10 is pressed down on dough.

FIG. 15 is a top view of the slide plate 3 from FIG. 12.

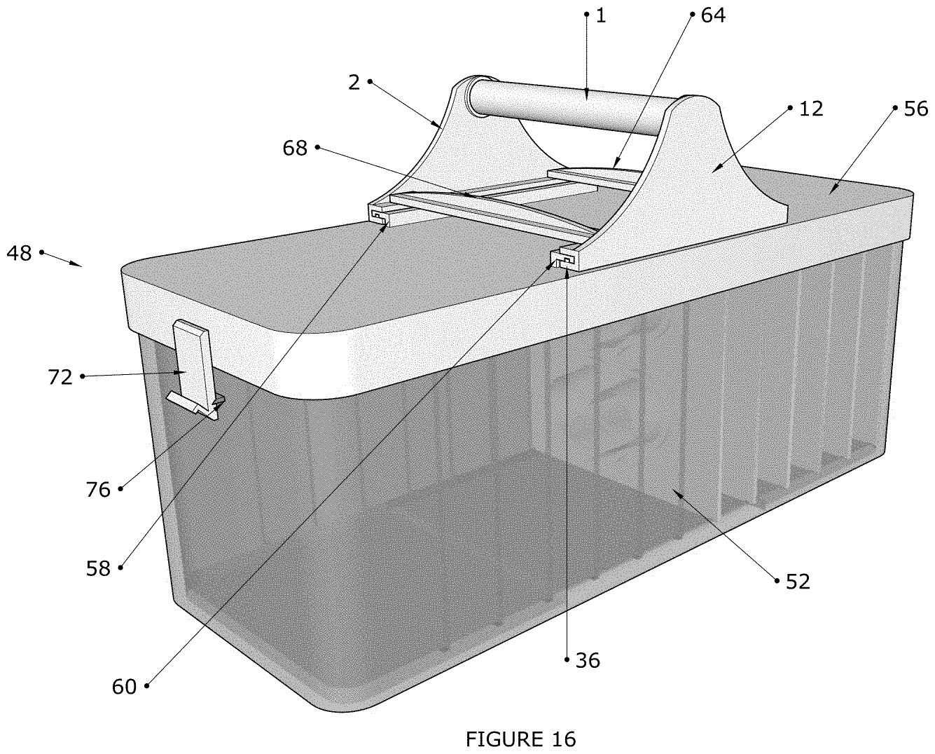

FIG. 16 shows a perspective view of a storage container 48. The storage container 48 comprises a main body 52, a lid 56 removeably attachable to the body 48. In addition, the handle 1 and the two side members 2, 12 are removeably attachable to the top of the lid 52. The lid 56 may attach to the main body via any suitable fastener, or even an interference fit. In one shown in embodiment, the lid 56 attaches to the main body via a flexible latch 72 and catch member 76.

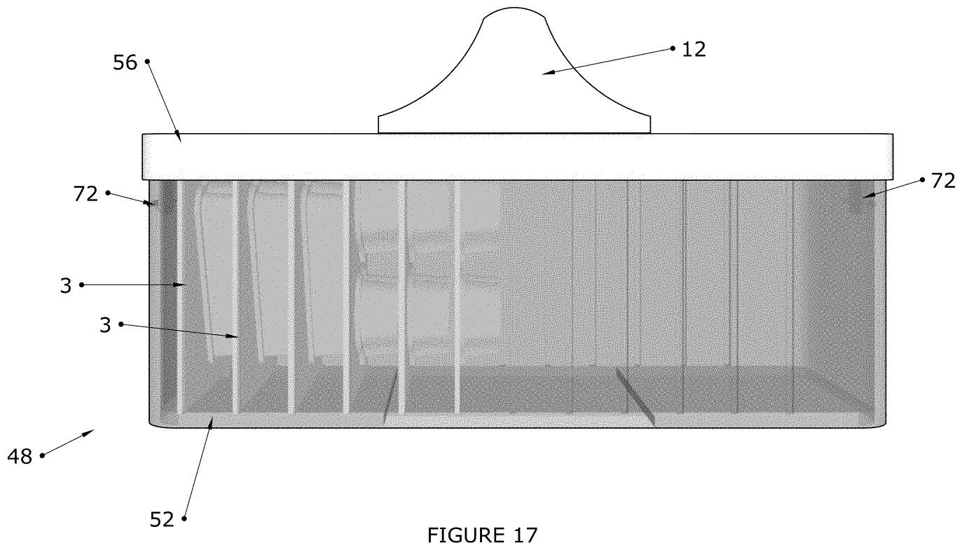

FIG. 17 shows a side view of the storage container 48. In this view, the main body 52 is semi-transparent to show that several slide plates 3 can be stored inside the main body 52.

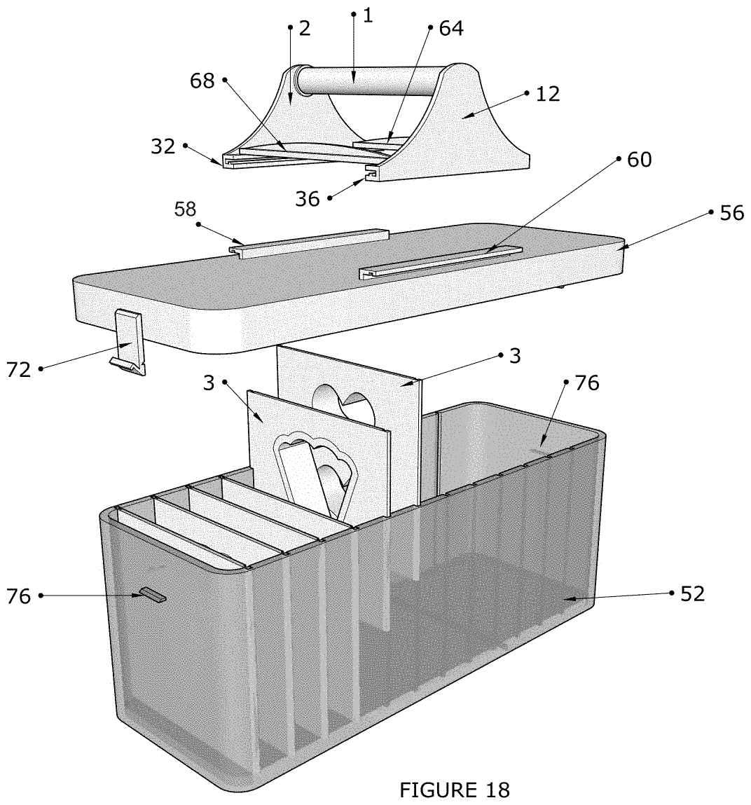

FIG. 18 is a perspective assembly view of the storage container from FIGS. 16 and 17. The lid 56 has two lid square grooves 58, 60, which are configured to removeably slide onto the first square groove 32 and second square groove 36 of the first and second side member 2,12 respectively. The first lid square groove 58 is configured to slide onto and mate with the first square groove 32 of the first side member 2. Similarly, the second lid square groove 60 is configured to slide onto and mate with the second square groove 36 of the second side member 12.

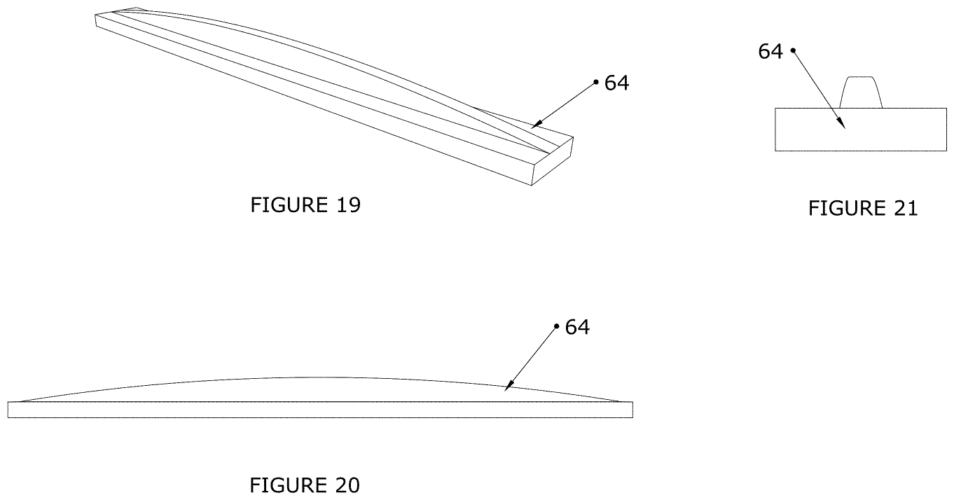

FIG. 19 shows a perspective view of one of the lateral support members 64.

FIG. 20 shows a side view of the lateral support member from FIG. 19.

FIG. 21 shows a front view of the lateral support member from FIG. 19.

In use, a user may insert one slide plate 3 into the first and second side members 2, 12, and use the cookie cutter pattern 4 on the slide plate 3 to cut dough. The user may remove the one slide plate 3 from the first second side members 2, 12, and insert a different slide plate 3 with a different cookie pattern 4 on the slide plate 3, in order to cut different dough shapes. The user may change out a plurality of slide plates 3 into the side members 2, 12 in order to have a wide variety of cookie cutter patterns 4 to make different shaped cuts in dough. If the user has the storage container 48, the user can store a plurality of slide plates 3 in the main body 52, and attach the handle 1, and two side members 2, 12 to the lid 56 of the storage container 48. The user can carry the storage container 48 via the handle 1.

The disclosed cookie cutter apparatus and system has many advantages. In a small footprint, one can have a variety of shapes for cutting dough. The slide plate can be easily changed out, to give one a variety of shapes one can cut dough into. The large handle makes it easy to punch out dough shapes. The storage container makes it easy to keep the varies slides and the cookie cutter in one place, preventing loss of pieces.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made, and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A cookie cutter apparatus comprising:
a horizontal handle, the horizontal handle having a first end, and a second end on an opposite end of the horizontal handle from the first end;
a first side member attached to one end of the horizontal handle;
a second side member attached to a second end of the horizontal handle;
a first slide plate configured to removeably attach to the first side member and second side member, the slide plate having a first cookie cutter pattern.

2. The cookie cutter apparatus of claim 1, further comprising:
a first square groove located on the first side member;
a second square groove located on the second side member;
a first slide square groove located on a first side of the slide plate;
a second slide square groove located on a second side, opposite the first side, of the slide plate; and
wherein the first slide square groove is configured to slide into and mate with the first square groove, and the second slide square groove is configured to slide into and mate with the second square groove.

3. The cookie cutter apparatus of claim 1, further comprising:
a second slide plate configured to removeably attach to the first side member and second side member, the second slide plate having a second cookie cutter pattern;

4. The cookie cutter apparatus of claim 3, further comprising:
a third slide plate configured to removeably attach to the first side member and second side member, the third slide plate having a third cookie cutter pattern;
a fourth slide plate configured to removeably attach to the first side member and second side member, the fourth slide plate having a fourth cookie cutter pattern;
a fifth slide plate configured to removeably attach to the first side member and second side member, the fifth slide plate having a fifth cookie cutter pattern; and
a sixth slide plate configured to removeably attach to the first side member and second side member, the sixth slide plate having a sixth cookie cutter pattern.

5. The cookie cutter apparatus of claim 1, wherein the horizontal handle has a cylindrical shape.

6. The cookie cutter apparatus of claim 1, wherein the horizontal handle is a round dowel.

7. The cookie cutter apparatus of claim 1, wherein the horizontal handle is a fixedly attached to the first side member and the second side member.

8. The cookie cutter apparatus of claim 1, wherein the horizontal handle is rotatably attached to the first side member and the second side member.

9. The cookie cutter apparatus of claim 1, wherein the horizontal handle, first side member and the second side member are manufactured as one piece.

10. The cookie cutter apparatus of claim 1, wherein the first side member is parallel to the second side member, and the slide plate is orthogonal to the first side member and the second side member, when the slide plate is attached to the first and second side members.

11. The cookie cutter apparatus of claim 1, wherein the distance between the handle and the slide plate when the slide plate is attached to the first side member and second side member is large enough for fingers of a user to grab onto the handle without the fingers abutting the slide plate.

12. A cookie cutter system comprising:
a horizontal handle, the horizontal handle having a first end, and a second end on the opposite end of the horizontal handle from the first end;
a first side member attached to one end of the horizontal handle;
a second side member attached to a second end of the horizontal handle;
a lid configured to removeably attach to the first side member and the second side member;
a main body, configured to removeably attach to the lid;
a first slide plate configured to removeably attach to the first side member and second side member, the slide plate having a first cookie cutter pattern;
a second slide plate configured to removeably attach to the first side member and second side member, the second slide plate having a second cookie cutter pattern;
a third slide plate configured to removeably attach to the first side member and second side member, the third slide plate having a third cookie cutter pattern; and
wherein the main body is configured to hold a plurality of slide plates.

13. The cookie cutter system of claim 12, further comprising:
a first square groove located on the first side member;
a second square groove located on the second side member;
a first lid square groove located on a top surface of the lid;
a second slide square groove located on the top surface of the lid;
wherein the first lid square groove is configured to slide into and mate with the first square groove, and the second lid square groove is configured to slide into and mate with the second square groove;
each of the slide plates having a first slide square groove located on a first side of the slide plate;
each of the slide plates having a second slide square groove located on a second side, opposite the first side, of the slide plate; and
wherein each of the slide plates are configured to slide into and mate with the first square groove and the second square groove via each side plate's respective first slide square groove and second slide square groove.

14. The cookie cutter system of claim 12, wherein the lid is configured to store a plurality of slide plates.

15. The cookie cutter apparatus of claim 2, further comprising:
a first lateral support member attached to the top of the first square groove and second square groove.

16. The cookie cutter apparatus of claim 15, further comprising:
a second lateral support member attached to the top of the first square groove and second square groove.
